(19) United States
(12) Patent Application Publication
(10) Pub. No.: US 2004/0025509 A1
(43) Pub. Date: Feb. 12, 2004

(54) COMPACT ROTARY RAMJET ENGINE GENERATOR SET

(75) Inventors: Shawn P. Lawlor, Redmond, WA (US); Robert C. Steele, Woodinville, WA (US)

Correspondence Address: R REAMS GOODLOE, JR. & R. REAMS GOODLOE, P.S., 24722 104TH. AVENUE S.E., SUITE 102, KENT, WA, 98030-5322, US

(73) Assignee: RAMGEN POWER SYSTEMS, INC.

(21) Appl. No.: 10/201,712

(22) Filed: Jul. 23, 2002

Related U.S. Application Data
(60) Provisional application No. 60/386,196, filed on Jul. 23, 2001.

(51) Int. Cl. F02C 3/16

(52) U.S. Cl. 60/772; 60/39.35

(57) ABSTRACT

A rotary ramjet engine generator set. An exemplary embodiment of a rotary ramjet engine is provided operating with a very low axial flow component. The engine has a closely housed rotor and shaft mounted for rotary motion with respect to an engine case. A plurality of ramjet combustors are provided at the periphery of the rotor, and a pair of spaced apart helical strakes are provided extending outward from the surface portion of the rotor toward the interior wall of the engine case, less a running clearance therefrom. An inlet centerbody is provided for each ramjet. The centerbody is disposed along a helical axis parallel to the strakes, and includes a leading edge structure, a pair of sidewalls defining therebetween a shaped cavity, and a rear end wall. Each pair of strakes cooperate to define, rearward of the rear end wall of each inlet centerbody, a combustion chamber for mixing therewithin and inlet fluid and burning fuel therein to form hot combustion gases therefrom. A ramjet exit structure, including a converging ramjet nozzle, nozzle throat, and diverging ramjet nozzle are provided for receiving the hot combustion gases and discharging, at a preselected helical angle to the plane of rotation of the rotor, a jet of hot exhaust gases. An electrical generator is provided operatively coupled with the shaft of the rotor.

### RELATED PATENT APPLICATIONS

This invention is related to my U.S. Provisional Patent Application Express Mail No. EUEU230416501US (petition to convert to provisional patent application filed Jul. 17, 2002), converted from prior U.S. patent application Ser. No. 09/912,226, filed on Jul. 23, 2001, entitled Compact Rotary Ramjet Engine Generator Set, the disclosure of which is incorporated herein in its entirety by this reference.

A portion of the disclosure of this patent document contains material that is subject to copyright protection. The patent owner has no objection to the facsimile reproduction by anyone of the patent document or the patent disclosure, as it appears in the Patent and Trademark Office patent file or records, but otherwise reserves all copyright rights whatsoever.

1. Technical Field

This invention relates to the field of power generation. More particularly, the invention relates to compact stationary power generation units utilizing ramjets for creating shaft power, and using such power for electrical generation.

2. Background

Over the years, aero-derivitive gas turbine engines have been successfully adapted for use in stationary power generation devices. However, reductions in complexity of such generation devices, as necessary in order to reduce maintenance costs, would still be desirable. Historically, various unconventional gas turbine designs have been proposed in an attempt to fill this void. One such design was suggested by Campbell, in U.S. Pat. No. 3,557,551, issued Jan. 26, 1971, showing a gas turbine engine with rotating combustion chambers and high nozzle velocities. However, that device, like many others, did not adequately address the aerodynamic features necessary to reduce parasitic “∫PdA” drag (i.e., aerodynamic pressure P acting over an exposed area A), or the friction drag of high speed rotating elements, to within economically tolerable limits in order to beneficially deploy such technology at higher (e.g., supersonic) inlet velocities.

Further, although there have been various attempts at developing an apparatus that incorporates the use of ramjet engines for the production of stationary power, most of such designs as taught by others have been practically incapable of operation at even moderate supersonic speeds, or were potentially capable of such operation only at low Mach numbers and with considerable aerodynamic drag losses. Even where the use of ramjets operating at supersonic speeds and employing the use of oblique shock wave compression were envisioned, such as in Price, U.S. Pat. No. 2,579,049, such devices included an undesirably high number of rotating elements, necessitating carriage of large replacement parts inventories. Moreover, such designs were inherently inefficient for stationary power production, since such designs were based on high axial flow devices, where the bulk of the flow field occurs along the shaft axis, rather than on a tangential flow device, where the bulk of the flow field is oriented tangential to the rim of a rotor.

Thus, it would be desirable, particularly for distributed power applications, to provide a compact unit that produces the required generating capability while complying with strict environmental regulations (where applicable), and which operates with high net system efficiency. Also, it would be desirable to provide a compact rotary ramjet engine based generator set, and, more particularly, a rotary ramjet engine having an inlet air compressor (i.e., supercharger) for increasing power produced from a supersonic ramjet inlet and suitable combustion chamber structure. It would also be desirable that such an engine be provided with an optional impulse turbine stage for additional energy recovery, in order to enable the engine to maintain high efficiency power output even when provided in relatively small sizes, such as from less than 1000 kW up to about 10,000 kW of electrical power generation capability.

Depending upon the specific operating needs of a particular implementation, certain subsets of (or even all) of the foregoing can be implemented using various combinations of exemplary embodiments and aspects thereof described in the sections following.

### SUMMARY

One embodiment of a newly developed novel rotary ramjet engine based generator set design disclosed herein has, in series gas flow combination, rotating components including an inlet air compressor (supercharger) for increasing pressure to the inlet air supply (which pressure is subsequently converted to kinetic energy, i.e., swirl velocity, by inlet guide vanes) a rotary ramjet with a rotor having a rotating combustion chamber portion including a ramjet compression inlet, a flame holder, and an outlet nozzle. Optionally, an impulse turbine is provided for recovering kinetic energy from hot escaping combustion gases. The rotor has an output shaft operably connected, normally via a speed-adjusting gearbox, to an electrical generator. Adjacent static housing for the rotating components is provided to define an inlet air compressor discharge duct, a substantially cylindrical engine casing wall circumferentially confining the rotary combustion chamber portion, and optionally, an impulse turbine casing for confining, receiving, and containing hot combustion gases before and after passage through the impulse turbine. An exhaust gas collection duct is provided to receive the hot exhaust gas flow. For added net system efficiency improvement, a heat recuperator is preferably (but optionally) supplied in the exhaust gas collection duct to recover thermal energy from the exhaust gas collection duct and generate pressurized steam therefrom. Such pressurized steam can be used directly in a steam section of the impulse turbine, or can be utilized elsewhere in a cogeneration heat recovery system.

The rotary ramjet design preferably utilizes an inlet centerbody in which ramjet compression is achieved at supersonic inlet inflow velocities, by exploiting an oblique shock extending from a leading edge structure laterally outwardly to, at the design velocity, confining inlet and outlet strakes. Preferably, the combustor and accompanying strakes are affixed to the rotor in a preselected, substantially matched helical angle orientation, so as to smoothly and continuously acquire clean inlet air and discharge the resulting products of combustion. The combustion chamber is simplified in that a rear wall of the inlet centerbody serves as a forward wall of a combustion chamber, providing for flame holding. By virtue of the rear wall of the inlet centerbody extending from the rim of the rotor outward to the cylindrical interior peripheral sidewall (less running clearance), a combustor cavity is defined to provide for through mixing of fuel and air, and to provide sufficient residence time for reaction of fuel with oxidant in order to minimize the escape of incomplete combustion products from the combustor.

The foregoing combustion chamber configuration provides for improved flame holding, better flame front development, and for improved mixing of fuel and air at supersonic inlet velocities. As stated previously, in this embodiment, the combustor flameholder extends outward from the rim of the rotor toward the stationary, substantially cylindrical tubular interior peripheral wall (less running clearance). In this manner, by the utilization of a rear wall of an inlet body, multiple shear layers are created, i.e., on both sides of the inlet centerbody, so that fuel/air mixing and flame front propagation characteristics are improved. The shear layers lead to the creation of mixing vortices behind the rear wall of the inlet centerbody (i.e., the flameholder) so as to provide for stable flameholding which is desirable at the design operational velocity.

Further, it is to be understood that although a combustor cavity having roughly a segmented annulus shape and having a substantially rectangular cross-section at any selected station along the flow path is depicted, other designs utilizing an inlet body rear wall flameholder shape other than that just described are also possible (e.g, non-rectangular cross-sectional shape). However, by optimizing combustor volume, the necessary circumferential length of the combustor is reduced, thus reducing “hot section” components of the ramjet engine.

Yet another aspect may include matching the axial and tangential flows at the inlet centerbody and at the exhaust outlet nozzle of the ramjet, providing a primarily tangential flow type engine is provided with reduced energy loss due to unmatched flow rates, or due to excess or unnecessary axial flow.

### BRIEF DESCRIPTION OF THE DRAWING

In order to enable the reader to attain a more complete appreciation of the invention, and of the novel features and the advantages thereof, attention is directed to the following detailed description when considered in connection with the accompanying drawings, wherein:

FIG. 1 shows a partially sectioned perspective view of a compact rotary ramjet engine, rail mounted and coupled with an electrical generator and starting motor.

FIG. 2 shows a side elevation view of a 800 kW size compact rotary ramjet engine, further illustrating the components set forth in FIG. 1 above.

FIG. 3 shows a rear end view of the 800 kW size compact rotary ramjet engine just set forth in FIG. 2 above.

FIG. 4 shows a front-end view of the 800 kW size compact rotary ramjet engine just set forth in FIG. 3 above.

FIG. 5 shows a partially broken away perspective view a compact rotary ramjet engine, showing a pre-swirl compressor to act on the air inlet, fuel injection nozzles, the use of inlet air guide vanes, a rotary ramjet with inlet and outlet strakes and an inlet centerbody accompanying one ramjet combustor, an impulse turbine to receive hot exhaust gases exiting the ramjet combustor, and the related planetary gear set for coupling output power from the impulse turbine to the output shaft.

FIG. 6 is a partially broken away perspective view of the steam turbine portion of the impulse turbine, illustrating the steam turbine blading, inlet nozzles, a low pressure steam capture annulus, and an outlet heat exchanger (heat recouperator) for capturing heat from exhaust gases.

FIG. 7 is a vertical cross-sectional view of the compact rotary ramjet engine similar to that first illustrated in FIG. 5 above, but now shown in a simplified configuration that omits the optional steam turbine system features.

FIG. 8 illustrates the recovery of heat from hot exhaust gas to create pressurized steam for use in the steam turbine, to provide additional shaft power in the compact rotary ramjet engine.

FIG. 9 illustrates the recovery of heat from the exhaust gas for use by in an external heating load requirement, so as to enhance overall cycle efficiency during use of the compact rotary ramjet engine.

FIG. 10 is a graphical representation of the net system efficiency of the compact rotary ramjet engine described herein, as compared to a conventional gas turbine engine.

FIG. 11 is a graphical representation of the net system efficiency of the compact rotary ramjet engine described herein, when operating with and without a steam recuperation cycle.

FIG. 12 illustrates the use of a compound impulse turbine blade, where a portion of the blade includes steam buckets, and a portion of the blade is configured to react to a high velocity hot exhaust gas stream, and where housing portions are shown to separate the steam and the exhaust gas paths.

The foregoing figures, being merely exemplary, contain various elements that may be present or omitted from actual implementations depending upon the circumstances. An attempt has been made to draw the figures in a way that illustrates at least those elements that are significant for an understanding of the various embodiments and aspects of the invention. However, various other elements of the rotary ramjet engine are also shown and briefly described to enable the reader to understand how various optional features may be utilized in order to provide an efficient, reliable engine.

### DETAILED DESCRIPTION

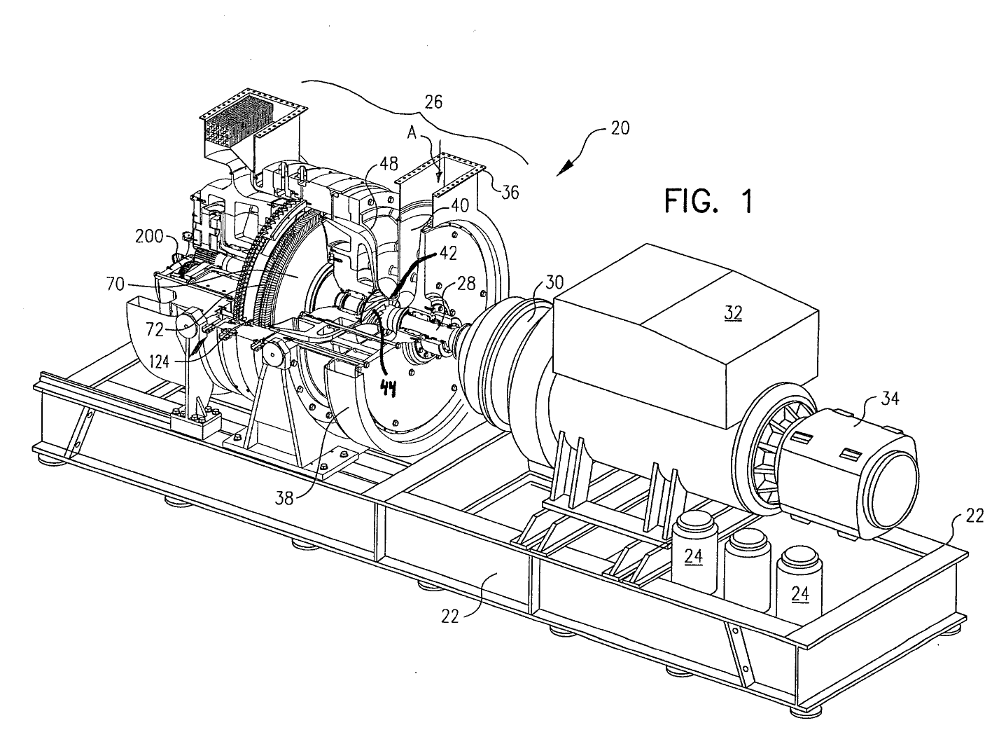

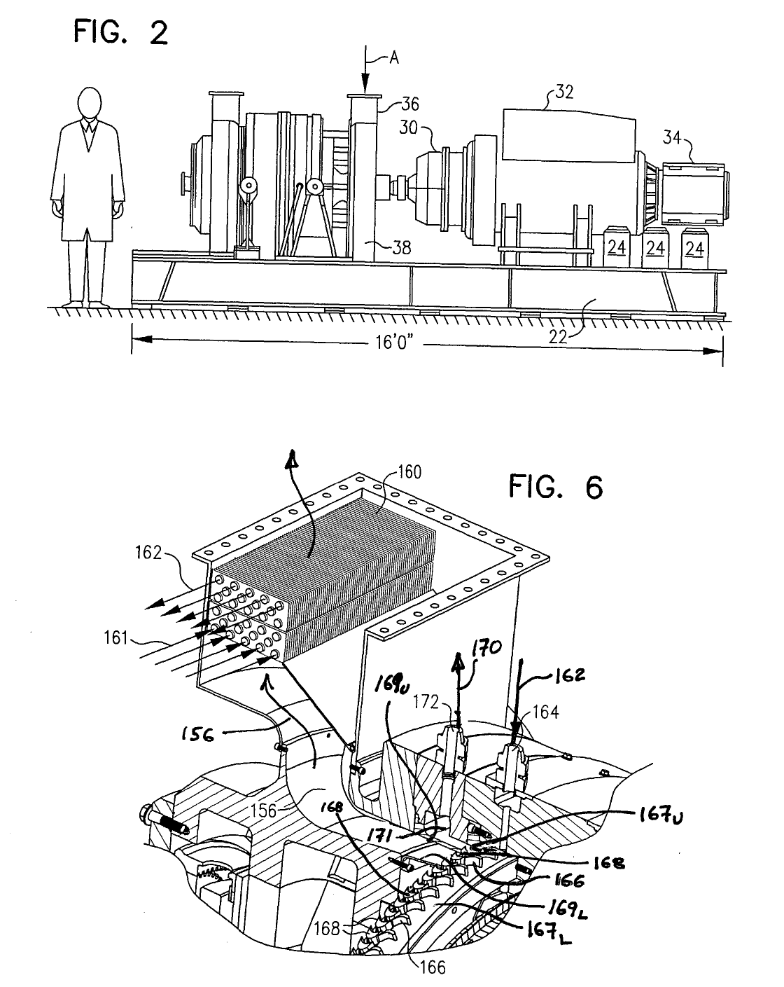

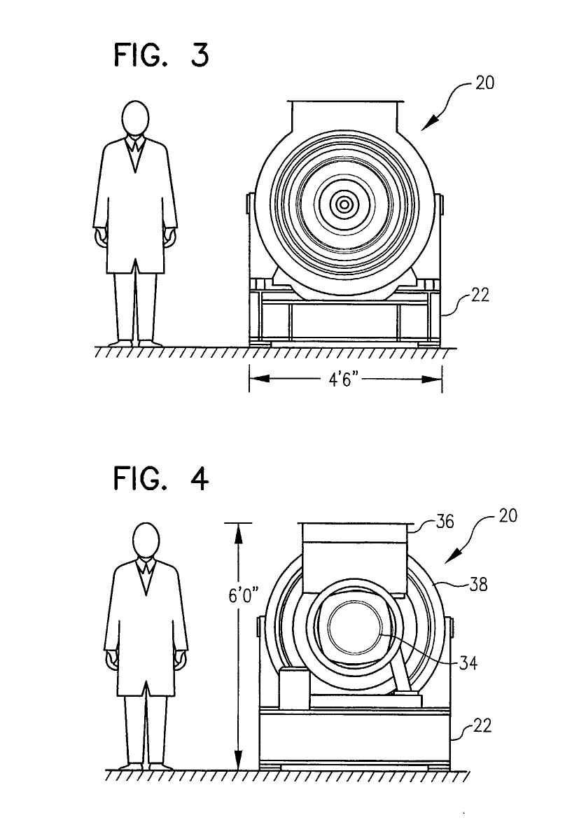

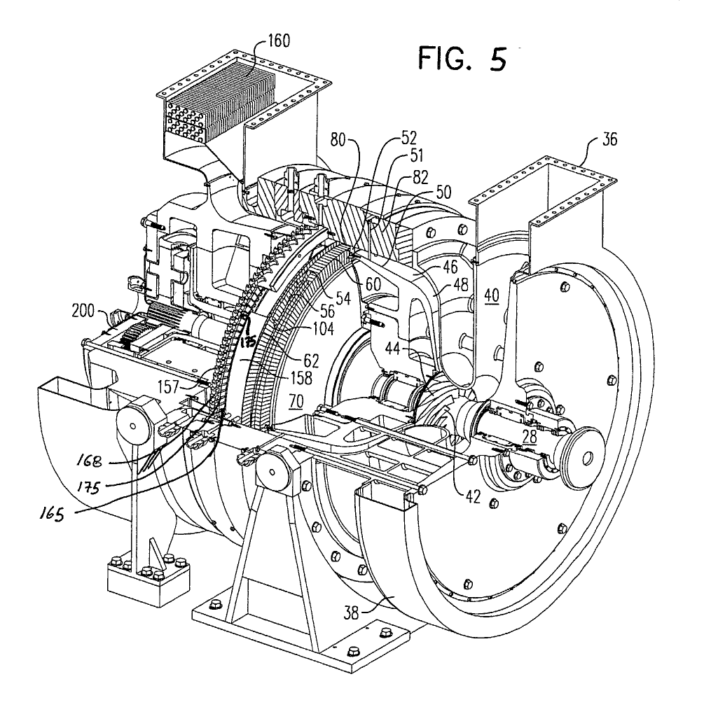

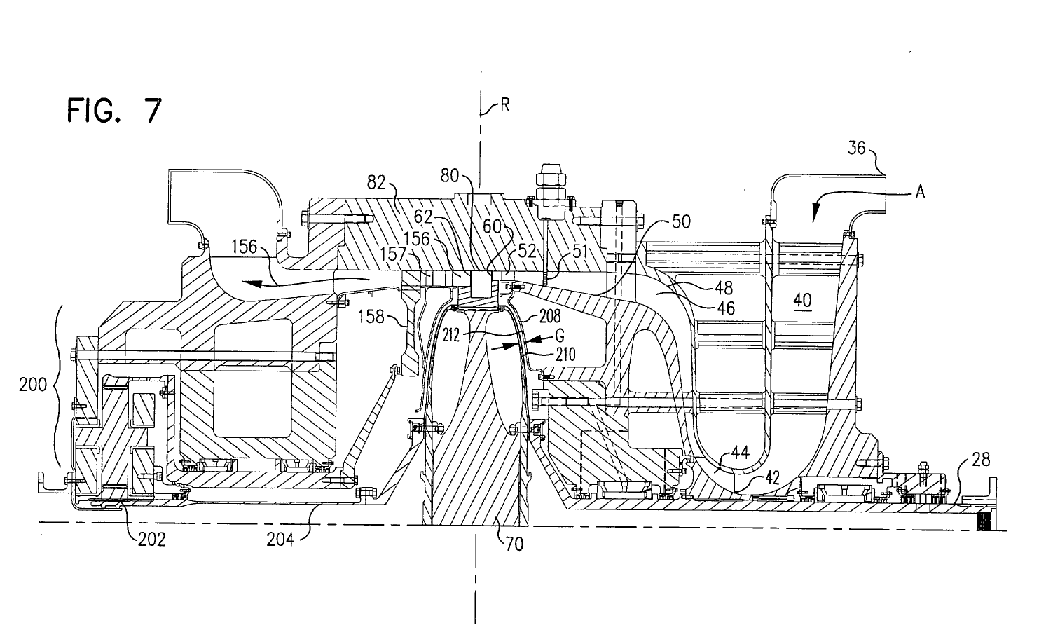

A perspective overview of an exemplary embodiment of a compact electrical generator set 20 is provided in FIG. 1. Basic components include the rail frame skid 22 with integral lubrication oil reservoir and adjacent lube oil pumps, the compact rotary ramjet engine 26 with output shaft 28, a gearbox 30, an electrical generator 32, and a starter motor 34. Inlet air as indicated by reference letter A is supplied via inlet duct 36 to a circumferential inlet air supply plenum 38 and thence through radial air inlet 40 for supply to a pre-swirl compressor inlet 42. From compressor inlet 42 a pre-swirl compressor 44 provides compression of the inlet air A. In a preferred embodiment, the compressed inlet air is allowed to decelerate in a diffuser portion 46 of pre-swirl compressor outlet duct 48, to build a reservoir of low velocity pressurized inlet air. Subsequently, converging portion 50 of outlet duct 48 accelerates inlet air, and directs the air over the primary fuel injectors 51. Then, the resultant fuel air mixture is deflected and accelerated by inlet guide vanes 52 (of which only one guide vane 52 in the guide-vane row is shown in FIG. 1) to provide both axial and tangential ramjet inlet velocities as required to produce, at design conditions, a negligible inflow angle of attack at the leading edge 54 of the ramjet inlet centerbody 56. This is illustrated in additional detail in FIGS. 5 and 7. Inlet and exhaust strakes 60 and 62, respectively, are preferably spiral or helical in shape, and are offset at a helical angle from the plane of rotation R of the rotor 70 at the same matching angle, as noted in FIG. 7. The exemplary technique of providing lean pre-mixed fuel at negligible angle of attack enables the inlet fluid to be supplied with minimal pressure loss, viscous fluid flow complications, or parasitic power losses.

The supersonic ramjet inlet utilizes the kinetic energy inherent in the air mass or fuel/air premix due to the relative velocity between the ramjet inlet and the supplied air or fuel/air premix stream, by compressing the inlet air (or, alternately, the inlet fuel/air mixture), preferably via an oblique shock wave structure. As illustrated herein, in order to carry out reliable, thorough combustion in the combustion chamber 72, the inlet stream is compressed utilizing a flow pattern operating with compression primarily laterally with respect to the plane of rotation of the rotor 70, to compress the inlet fuel/air mix between the inlet centerbody 56 and adjacent inlet 60 and outlet 62 strake structures. Of course, as can be appreciated from FIGS. 5 and 7, the compressed inlet fuel/air mix is also contained by the substantially cylindrical tubular interior sidewall portion 80 of the engine casing 82. In the rotary ramjet engine shown herein, the compression and combustion is achieved utilizing only a small number of ramjets, (normally expected to be in the range from 2 to 5 total, with accompanying inlet and outlet strakes for each ramjet), and within an aerodynamic duct formed by the spirally disposed, or more specifically, helically disposed inlet 60 and outlet 62 strakes, as opposed to a traditional gas turbine or other axial flow compressor using many rotor and stator blades.

In situations where environmental concerns are significant, in order to obtain the proper conditions for combustion while producing low-pollution products of combustion, the fuel and combustion air may be premixed prior to feed to the ramjet inlet. As illustrated in FIG. 7, fuel injectors 51 add the fuel to an inlet fluid (which may be either be a fuel free oxidant containing stream, or which may contain some high value fuel such as hydrogen, or some low value fuel, such as coal bed methane, coal mine purge gas, landfill methane, biomass produced fuel gas, sub-quality natural gas, or other low grade fuels) provided through diffuser portion 46 of compressor outlet duct 48. In order to carry out the actual combustion step in an operationally reliable manner, the velocity of the compressed inlet fuel/air mixture should preferably be high at the intermixing point between the combustion chamber and the delivery point of the combustible fuel/air mixture, so that flashback of the flame front from the combustor toward the inlet is reduced or avoided. In the exemplary rotary ramjet engine and operating conditions described herein, the residence time in the diffuser is too short, and the total pressure too low, to initiate an auto-ignition process. Further, by the time the premix is compressed and heated, the in-flowing fluid has entered the combustion chamber, and thus ignition or detonation is entirely avoided in this engine design, unlike, for example the situation in the usual gas turbine compressor section design.

In order to stabilize the combustion process downstream of the rear wall 104 of inlet centerbody 56 may be stabilized by substantially reducing the velocity through the combustion chamber 72 by providing a combustion chamber 72 having larger flow area than provided by the inlet ducts thereto. Localized recirculation zones may also be provided in order to have an adequate residence time to substantially eliminate creation of carbon monoxide in the combustor. In the base design illustrated herein, a combustion chamber 72 with a constant duct height and a predetermined overall length L_{C} is provided. Preferably, this overall length L_{C} is determined by providing a combustor residence time of about 5 ms to about 10 ms, more or less, as based on equilibrium flame temperature predictions sufficient for CO oxidation to CO₂ to leave only a environmentally acceptable CO quantity in the high energy hot exhaust gases. The high energy hot exhaust gas exits the combustion chamber 72 through an outlet nozzle 124 and thus propels the rotor 70 at the desired rim speed under design load conditions. Accordingly, in the ramjet configuration illustrated, the acceleration and deceleration of the inlet fluid, and the acceleration and deceleration of the outlet combustion gases, is accomplished efficiently.

Returning now to FIGS. 7, the hot exhaust gases (products of combustion) 156, directly after discharge from the combustion chamber 72 flow through the ramjet outlet nozzle 124, and thence along the outlet strake 62, and are directed, preferably at low pressure but still containing axial and tangential swirl kinetic energy to exhaust gas blade portions 157 in an impulse turbine 158, for extraction of the kinetic energy based on the overall swirl energy inherent in such hot exhaust gases 156. For enhanced efficiency, as illustrated in FIGS. 6 and 9, the hot exhaust gases 156 may be further utilized by being directed to an exhaust heat exchanger 160 to heat condensate 161 and produce steam 162.

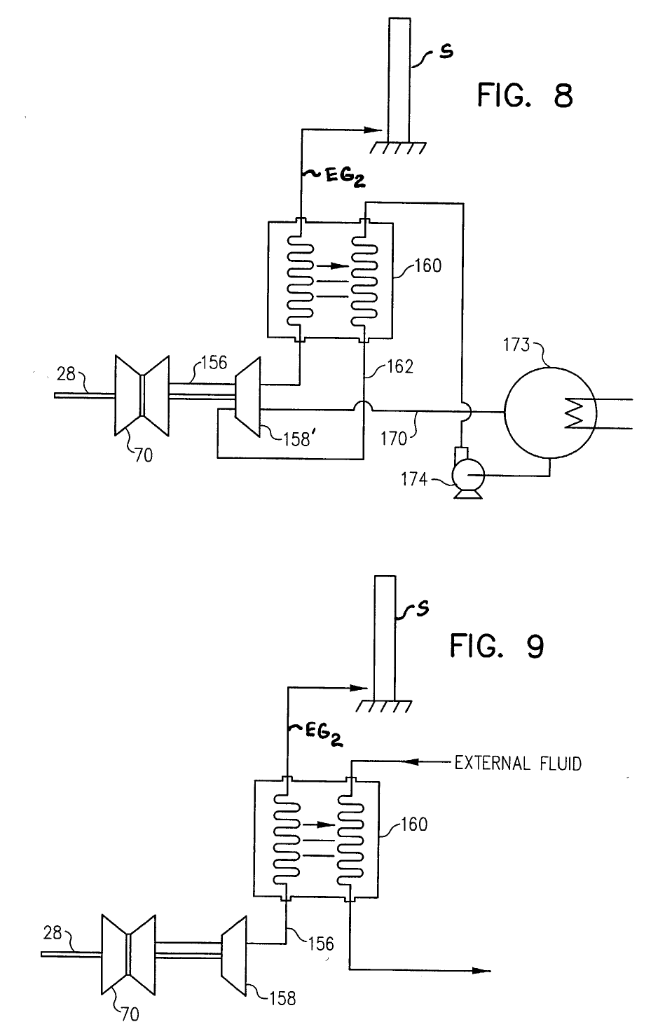

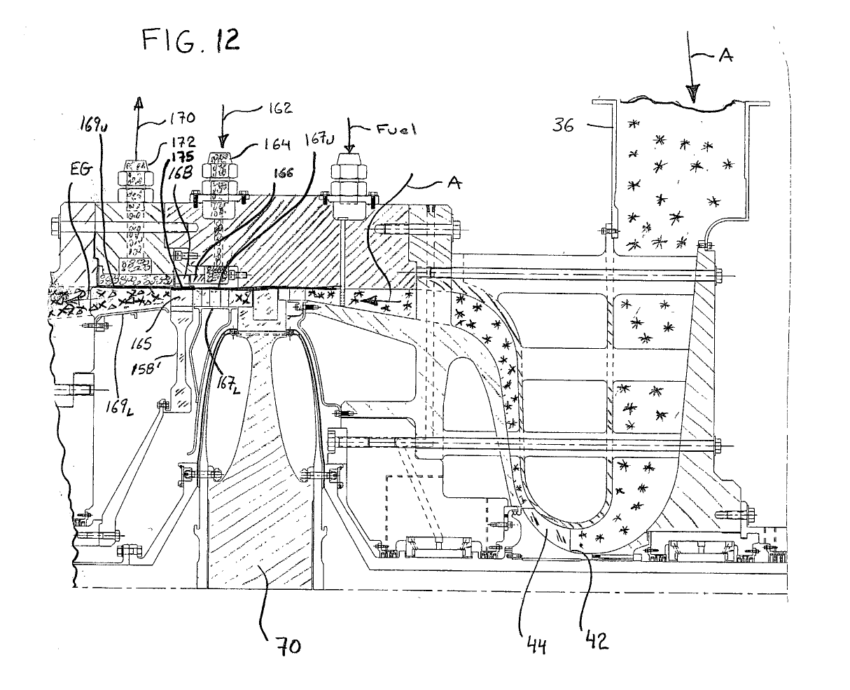

For yet further enhanced efficiency, in another configuration as further illustrated in FIGS. 6, 8 and 12, the steam 162 may be directed through high-pressure steam supply ports 164 and thence through inlet vanes (nozzles) 166, preferably fixed in orientation, and thence into the steam blade 168 portions of compound impulse turbine blades 158′. In such a configuration, the compound impulse turbine blades 158′ have two distinct flow regions, an outer blade 168 for receiving steam, and an inner blade 165 for receiving exhaust gas. To reduce leakage, on the embodiment shown in FIG. 12, the outer blade portion 168 is of smaller length, longitudinally in the flow direction, than the inner blade portion 165. In such manner, close fitting lower upstream housing 167_{L} and upper upstream housing portion 167_{U}, as well as lower downstream housing portion 169_{L} and upper downstream housing portion 169_{U} channel exhaust gas away from the outer or steam blade portion 168. In FIG. 12, the flow of cool air supplied for combustion is indicated with “*” symbols in flow stream indicated by reference arrow A. After combustion in the ramjet combustion chamber 72, in the same FIG. 12, hot combustion gases EG are indicated by a “+” and “triangle” notations. Above the hot combustion gases, the flow of steam is shown using “o's” to depict steam. In this regard, as noted above, the high pressure steam 162 may be directed through high-pressure steam supply ports 164 and thence through fixed inlet vanes (see nozzles 166 in FIG. 6), preferably fixed in orientation, and thence into the steam bucket or blade 168 portions of compound impulse turbine blades 158′. As noted in FIG. 12, the low pressure steam 170 is exhausted from the impulse turbine steam blade portion 168 through low pressure steam chamber 171 via low pressure steam discharge ports 172 and is directed to a condenser 173 (see FIG. 8) and sent via pump 174 to the heat exchanger 160 for replenishment of the supply of high pressure steam 162 to be sent to the high pressure steam supply nozzles 164 mentioned above, for acting on the compound turbine blades 158′. On one embodiment, the compound turbine blade 158′ has an annular arc platform segment 175 between the steam bucket portion 168 and the hot gas portion 165. The annular arc platform segments 175 on adjacent compound turbine blades 158′ cooperate to provide a substantially continuous annular ring, so as to effectively maintain separation of steam and hot gas.

Alternately, as depicted in FIGS. 7 and 9, the use of steam buckets 168 and related components in connection with the impulse turbine 158′ may be omitted, and the use of a simple turbine blade 158 acting on exhaust gases only may be utilized. In either event, cooled exhaust gases EG₂ are sent to a stack S for discharge.

Returning now to FIGS. 5 and 7, note that in order to match optimum tangential speed of rotor 70 and the desired rotational speed of impulse turbine 158, a planetary gear system 200 is used for transmission of power from the impulse turbine 158 to a geared spline 202 on shaft portion 204. The impulse turbine 158 is not directly affixed to, and turns at a different speed than, rotor 70. Additionally, it should be noted that in order to minimize aerodynamic drag and efficiently operate the outer portions of the rotor 70 at supersonic tangential velocities, means could be provided to reduce drag of the rotor 70. This can take the form of a fixed housing 208 with a small interior gap G between the rotor surface 210 and an interior 212 of housing 208, or, alternately, take the form of a vacuum means to remove air from adjacent the rotor 70. Such rotor drag minimizing techniques are taught in U.S. Pat. No. 5,372,005, issued Dec. 14, 1994 to Lawlor, the disclosure of which is incorporated herein by this reference.

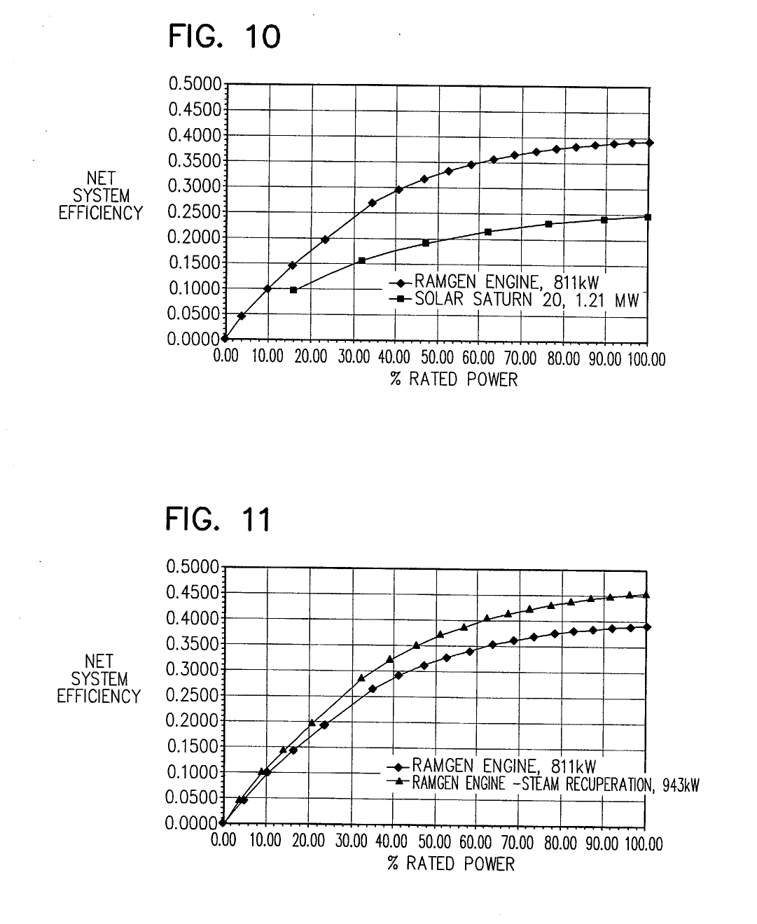

As noted in FIGS. 10 and 11, the just described exemplary ramjet engine generator set at the described exemplary operating conditions has a net system efficiency at rated power of at least 32%, and more preferably, of at least 35%, and most preferably, from about 37% to about 39%, when operating using an impulse turbine for recovery of kinetic energy from hot exhaust gases, but without a steam turbine. When a steam turbine is employed, the net system efficiency at rated power output is preferably at least 35%. More preferably, the net system efficiency at rated power output of such a system configuration is at least 38%, and most preferably, from about 45% to about 46%.

It is to be appreciated that various aspects and embodiments of the compact rotary ramjet engine designs described herein are an important improvement in the state of the art of rotary ramjet engines. Although only a few exemplary embodiments have been described in detail, various details are sufficiently set forth in the drawings and in the specification provided herein to enable one of ordinary skill in the art to make and use the invention(s), which need not be further described by additional writing in this detailed description. Importantly, the aspects and embodiments described and claimed herein may be modified from those shown without materially departing from the novel teachings and advantages provided by this invention, and may be embodied in other specific forms without departing from the spirit or essential characteristics thereof. Therefore, the embodiments presented herein are to be considered in all respects as illustrative and not restrictive. As such, this disclosure is intended to cover the structures described herein and not only structural equivalents thereof, but also equivalent structures. Numerous modifications and variations are possible in light of the above teachings. It is therefore to be understood that within the scope of the appended claims, the invention(s) may be practiced otherwise than as specifically described herein. Thus, the scope of the invention(s), as set forth in the appended claims, and as indicated by the drawing and by the foregoing description, is intended to include variations from the embodiments provided which are nevertheless described by the broad interpretation and range properly afforded to the plain meaning of the claims set forth below.

1. A ramjet engine comprising, in combination:
(a) rotating components, in series flow, including:
(1) an inlet air compressor,
(2) a rotary ramjet, said rotary ramjet comprising (A) a rotor and (B) at least one rotary combustion chamber portion comprising (i) a ramjet compression inlet, (ii) a flame holder, and (iii) an outlet nozzle on a rotor;
(3) an impulse turbine;
(b) an adjacent static housing comprising:
(1) an inlet air compressor discharge duct;
(2) an engine casing having an inner wall surface defining a static combustion chamber portion adapted to work with said rotary combustion chamber portion to receive fuel from a fuel supply and inlet air from said inlet air compressor to burn said fuel and produce a hot exhaust gas flow to impart rotary motion to said rotor; and
(3) an external turbine casing peripherally confining said impulse turbine, said impulse turbine adapted to receive said hot exhaust gas flow; and
(4) an exhaust collection duct, said exhaust collection duct receiving said hot exhaust gas flow after passage of same through said impulse turbine.

2. The apparatus as set forth in claim 1, wherein a plurality of combustion chamber portions are provided spaced about said rotor.

3. The apparatus as set forth in claim 1, further comprising a transmission, said transmission coupled with and configured to receive rotary motion from said impulse turbine and to deliver said rotary motion to a first output shaft.

4. The apparatus as set forth in claim 1, wherein said inlet air compressor and said rotary ramjet are shaft coupled for direct mechanical action therebetween.

5. The apparatus as set forth in claim 1, wherein said inlet air compressor comprises a pre-swirl impeller.

6. The apparatus as set forth in claim 5, wherein said pre-swirl impeller is configured to impart inlet air in the direction of rotation of said shaft.

7. The apparatus as set forth in claim 6, further comprising inlet guide vanes, said inlet guide vanes configured to provide a preselected angle of incidence inlet air to said ramjet compression inlet.

8. The apparatus as set forth in claim 1, wherein said rotor further comprises a rim, and wherein each of said static combustion chamber system portions are mounted at said rim of said rotor.

9. The apparatus as set forth in claim 8, wherein at least one rotary combustion chamber portion is configured in a preselected contour, and wherein said contour comprises an isentropic nozzle configuration.

10. The apparatus as set forth in claim 1, wherein each of said at least one rotary combustion chamber portion is disposed in a helical flow path on said rim of said rotor.

11. The apparatus as set forth in claim 9, wherein said at least one rotary combustion chamber portion further comprises an inlet helical strake and an outlet helical strake.

12. The apparatus as set forth in claim 1, further comprising, between said rotary ramjet and said impulse turbine, a plurality of stators.

13. The apparatus as set forth in claim 11, further comprising steam injection ports, said steam injection ports adapted to provide high pressurized steam to said stators for redirection to said impulse turbine.

14. The apparatus as set forth in claim 13, wherein said apparatus further comprises, downstream of said impulse turbine, a steam receiving duct and a low pressure steam outlet.

15. The apparatus as set forth in claim 1, wherein net system efficiency at rated power is at least 30%.

16. The apparatus as set forth in claim 1, wherein net system efficiency at rated power is at least 35%.

17. The apparatus as set forth in claim 12, or in claim 13, wherein net system efficiency at rated power output is at least 38%.

18. The apparatus as set forth in claim 12, or in claim 13, wherein net system efficiency at rated power output is at least 45%.

19. The apparatus as set forth in claim 1, further comprising a heat recovery steam generator, said heat recovery steam generator adapted to receive and cool said hot exhaust gas flow and to produce pressurized steam therefrom.

20. The apparatus as set forth in claim 19, further comprising a steam turbine, said steam turbine having a steam turbine output shaft, said steam turbine adapted to receive said pressurized steam and generate shaft power therefrom.

21. The apparatus as set forth in claim 1 or in claim 20, further comprising a first electrical generator, said first electrical generator driven by said rotor shaft.

22. The apparatus as set forth in claim 21, further comprising a second electrical generator, and wherein said second electrical generator is driven by said steam turbine output shaft.

23. A rotary ramjet engine generator set, said generator set comprising:
(a) an engine case comprising an interior wall;
(b) a rotor and shaft rotatably disposed with respect to said engine case,
(i) said shaft oriented along a longitudinal axis, and
(ii) said rotor disposed for rotary motion in a plane perpendicular to said longitudinal axis, and
(iii) said rotor having a rim surface portion;
(c) at least one pair of spaced apart strakes,
(i) said pair of strakes disposed along a first helical axis with respect to said plane of rotary motion of said rotor,
(ii) and each of said at least one pair of strakes extending outward from said rim surface portion of said rotor toward said interior wall of said engine case, less a running clearance therefrom;
(d) at least one inlet centerbody for said pair of strakes, said inlet centerbody disposed along a second helical axis, said inlet centerbody comprising a leading edge structure, a pair of sidewalls defining therebetween a shaped cavity, and a rear end wall;
(e) wherein each of said pair of strakes cooperate to define, rearward of said rear end wall of said at least one inlet centerbody, a cavity for trapping and mixing therewithin said inlet fluid; and
(f) an electrical generator operatively coupled with said shaft of said rotor.

24. The apparatus as set forth in claim 1, wherein a plurality of rotary combustion chamber portions are provided.

25. The apparatus as set forth in claim 24, wherein the number of rotary combustion chamber portions is an integer between 1 and 5, inclusive.

26. A rotary ramjet engine generator set, said generator set comprising:
(a) an engine case means for containing said a rotor and a ramjet combustor, said engine case means comprising an interior wall means;
(b) a rotor and shaft rotatably mounted with respect to said engine case means,
(i) said shaft oriented along a longitudinal axis,
(ii) said rotor disposed for rotary motion in a plane perpendicular to said longitudinal axis, and
(iii) said rotor having a rim surface;
(c) at least one pair of spaced apart strakes,
(i) said pair of strakes disposed along a helical axis with respect to said plane of rotary motion of said rotor, and
(ii) each of said pair of strakes extending outward from said rim surface of said rotor toward said interior wall of said engine case, less a running clearance from said interior wall;
(d) at least one inlet centerbody located between said pair of strakes, said inlet centerbody disposed along a helical axis, said inlet centerbody comprising a leading edge, a pair of sidewalls defining therebetween a shaped cavity, and a rear end wall;
(e) said pair of strakes cooperating to define, rearward of said rear end wall, a combustion chamber means for mixing therewithin an inlet fluid and burning fuel therein to form hot combustion gases therefrom;
(f) a converging ramjet nozzle, a nozzle throat, and a diverging ramjet nozzle, all located to define an outlet for a jet of hot exhaust gases from said combustion chamber means at a preselected helical angle to said plane of rotation of said rotor;
(g) an electrical generator operatively connected to said shaft.

27. A method of generating power, said method comprising:
(a) providing a rotary ramjet engine, said engine comprising
(1) an engine case, said engine case comprising an interior wall;
(2) a rotor and shaft rotatably mounted with respect to said engine case,
(i) said shaft oriented along a longitudinal axis and said rotor disposed for rotary motion in a plane perpendicular to said longitudinal axis,
(ii) said rotor having a rim surface portion;
(3) at least one pair of spaced apart strakes,
(i) said pair of strakes disposed along a helical axis with respect to said plane of rotary motion of said rotor, and
(ii) said pair of strakes extending outward from said rim surface portion of said rotor toward said interior wall of said engine case, less a running clearance therefrom;
(4) at least one inlet centerbody for said pair of strakes,
(i) said at least one inlet centerbody disposed along a helical axis,
(ii) said at least one inlet centerbody comprising a leading edge structure, a pair of sidewalls defining therebetween a shaped cavity, and a rear end wall;
(5) wherein each of said pair of strakes cooperate to define, rearward of said rear end wall of said at least one inlet centerbody, a combustion chamber for mixing therewithin said inlet fluid and burning fuel therein to form hot combustion gases therefrom;
(6) a ramjet exit structure,
(i) said structure comprising a converging ramjet nozzle, nozzle throat, and diverging ramjet nozzle, said exit structure for receiving said hot combustion gases and discharging, at a preselected helical angle to said plane of rotation, a jet of hot exhaust gases;
(b) providing an electrical generator means operatively coupled with said ramjet engine.

28. The method as set forth in claim 27, wherein said inlet fluid comprises gaseous fuel from a source selected from the group comprising (a) coal bed methane, (b) coal mine purge gas, (c) landfill gas, and (d) biogas.

29. The method as set forth in claim 27, wherein said inlet fluid comprises gaseous fuel from a source selected from the group comprising (a) natural gas, (b) pipeline flare gas, (c) drilling flare gas, (e) propane, (f) gaseous hydrocarbon, and (g) hydrogen.

30. The apparatus as set forth in claim 13, wherein said impulse turbine comprises a plurality of compound turbine blades, said compound turbine blades comprising a steam bucket portion and a hot gas portion.

31. The apparatus as set forth in claim 30, wherein said compound turbine blade comprises an annular arc platform segment between said steam bucket portion and said hot gas portion, and where said platform segments on adjacent compound turbine blades cooperate to provide a substantially continuous annular ring, so as to effectively maintain separation of steam and hot gas.

32. The apparatus as set forth in claim 30, wherein said static housing comprises complementary inner and outer upstream housing portions, and complementary inner and outer downstream housing portions, said inner upstream housing and said inner downstream housing providing separation between an exhaust stream and a pressurized steam.
